(19) United States
(12) Patent Application Publication
(10) Pub. No.: US 2022/0402748 A1
(43) Pub. Date: Dec. 22, 2022

(54) Vapor control set screw valve

(71) Applicants: Theodore Cosgrove, St. Louis, MO (US); Robin Brown, Labadie, MO (US); Grenville Sutcliffe, Villa Ridge, MO (US); Theodore Sutcliffe, Villa Ridge, MO (US)

(72) Inventors: Theodore Cosgrove, St. Louis, MO (US); Robin Brown, Labadie, MO (US); Grenville Sutcliffe, Villa Ridge, MO (US); Theodore Sutcliffe, Villa Ridge, MO (US)

(21) Appl. No.: 17/803,260

(22) Filed: Apr. 6, 2022

Related U.S. Application Data
(60) Provisional application No. 63/259,135, filed on Jun. 22, 2021.

(51) Int. Cl. B67D 7/44; F16K 3/24

(52) U.S. Cl. CPC B67D 7/44; F16K 3/24

(57) ABSTRACT

A vapor control set screw valve applied into the handle of a fuel dispensing nozzle, including a valve bushing intermediately applied within the vapor return line within the handle, a set screw valve provided within the lateral channel formed of the bushing, an insert bushing applied to the dispenser handle, and the set screw, forming the valve, engaging within the insert bushing, and extending into the vapor return line bushing, to provide for its adjustment therein, to open or close the vapor return line within the nozzle in order to regulate and control the flow of the returning vapors being pumped back to the associated dispenser, and to the normally underground fuel storage tank associated with gasoline dispensing.

### CROSS REFERENCE TO RELATED APPLICATIONS

This application claims the benefit of U.S. Provisional Application No. 63/259,135, filed Jun. 28, 2021, the entirety of which is hereby incorporated by reference herein.

### FIELD OF THE INVENTION

This invention relates to the control of vapor emissions, such as during usage of a fuel dispensing system, and more particularly pertains to the return of the gasoline vapors through the fuel dispensing system back to the dispenser and the underground storage facility, adjusting for a minimum of the intermixing of ambient atmosphere with the vapors as they are captured and returned to the storage location.

### BACKGROUND OF THE INVENTION

A control of gasoline vapors, particularly during their dispensing into vehicles, has become of paramount concern to the environmentalist, and the populous in general, with the concerns being that such vapors have an adverse effect upon the atmosphere, that can lead towards pollution, climate warming, and other suggested adverse environmental conditions. As a result, over the past decades, government regulations have provided strict controls on the collection and return of fuel vapors, back to a storage position, and to prevent their emission freely into the atmosphere, resulting in deleterious results, as has been advised.

More specifically, mechanical controls have been added to the gasoline dispensing nozzles, where employed at the service stations, and have effectively, at least by government regulations, returned approximately 90-95% of the vapors, being captured, and sent back to the underground gasoline storage facilities, at most service stations. Such nozzles have included the balanced pressure type of nozzle, and over the past few decades, the vacuum assist type of nozzle that collects the vapors, returns them back through the nozzle, the vapor return line, generally through the use of a vapor pump employed in the dispenser, and forces such vapors back into the underground gasoline storage tank, as is understood. These have been reasonably effective, to achieve their intended results, broadly, to lessen the escape of such deleterious vapors into the atmosphere.

One problem, though, as can be understood, is that when the vacuum pump of the dispenser is effectively attracting back in the gasoline vapors, at the region of the installation of the gasoline dispensing nozzle into the fill pipe of the vehicle, the general suction attained through use of such a vacuum pump also has a tendency to draw back into the nozzle clean ambient atmospheric air, that dilutes the returning gasoline vapors, an occurrence which is not acceptable, nor desirable, since it lessens the drawback of the pure gasoline vapors, alone, when captured from the vicinity of the operations of the dispensing nozzle, when filling a vehicle tank. This overstocks the mixed air into the underground storage tank.

There are all types of expensive controls that have been devised, as the method and apparatus for attaining vapor recovery, and to be able to monitor its effectiveness, such as can be seen in the U.S. Pat. No. 8,448,675, upon such a system. Other patents that show far more technical apparatus and system for assuring effective vapor recovery, in its performance, as can be seen the related U.S. Pat. No. 6,836,732. Other types of methods and apparatus for attaining vapor recovery, and monitoring the same, can be seen in the published applications No. U.S. 2020/0149647; No. U.S. 2014/0366627; No. U.S. 2014/0076421; No. U.S. 2013/0110419; No. U.S. 2012/0145933; No. U.S. 2011/0272063; and No. U.S. 2011/0219860. These all show various types of dispensing nozzles, and systems, for the effective recovery of gasoline vapors, and the monitoring of such systems.

These are the prior art materials known to the Applicants relating to this technology.

### SUMMARY OF THE INVENTION

This invention primarily relates to vapor recovery associated with the dispensing of fuel from a fuel dispensing nozzle, in the various vehicles or containers, and more particularly, relates to a method for adjusting the vapor recovery content and system, so that the vapor recovery is more efficiently performed in returning pure vapors back to the dispensing facilities and the underground storage tanks, with a minimum of intermixed fresh and clean atmospheric air associated with the returning vapors, so that the maximum amount of gasoline vapors are collected, and returned to storage, preventing their escape into the atmosphere, while at the same time minimizing the collection of ambient air.

The concept of this invention is to utilize a vapor control set screw type of valve, that is operatively associated with the fuel dispensing nozzle, cooperates with the vapor return line, so as to establish a back pressure for the returning vapors that have the effect of drawing in the maximum amount of fuel vapors, while minimizing the amount of ambient air. This is achieved through the use of various components that are built into the structure of the nozzle, and more particularly at its approximate incoming back end of the handle, where fuel enters into the nozzle, during dispensing, and at the same time, the vapor return line usually coaxially arranged therein returns the vapors back through the dispenser, and to the underground storage facility. Essentially, the structure utilizes a vapor bushing that is installed within the vapor return path, generally between the structured vapor return line that is designed into the handle of the dispensing nozzle, and where the vapor return hose enters into the back end of the nozzle, coaxially with or parallel to the incoming fuel flow line, for the nozzle handle, as known in the art. The bushing includes a vapor path through its interior, in alignment with the handle vapor return structure, and the vapor return hose, at this region of the nozzle handle, so as to allow for the movement of the vapors returning from the nozzle, and its passage to the fuel storage tank. The bushing has a lateral channel provided through it, and which intersects with the vapor return path through the said bushing, and into said lateral channel locates a set screw, formed having an inwardly extending valve, that is designed for adjustably being located within the vapor flow path of the vapor bushing, and which is adjustable, to allow for a build up of back pressure of the returning vapors, at that location, or when the set screw valve is partially removed, from said location, allows for a lessening of the vapor back pressure, at that location, to allow the dispenser pump to draw more of the deleterious vapors back into the nozzle, and transfer the same to the underground fuel storage, as known in the art.

To accommodate the fine adjustment of the set screw valve, the handle has an aperture extending through it, opening to the exterior of the handle, and into this portion of the opening is located a further insert bushing, with an accompanying O-ring, to provide for the sealing of the press fitting of this bushing into position within the surface of the handle, for accommodation of the location of the set screw valve, during its installation and adjustment during setting. The set screw valve has a threaded structure at its outer end, and which is designed for threading into the handle insert bushing, pressing tightly against its associated O-ring, in order to seal the installation of these components within the handle structure, during assembly, and to prevent the escape of vapors. The handle bushing has internal threads, and the outer end of the set screw valve also has outer threads, and the two engage together to provide for the manipulation of the set screw valve, during its adjustment.

During assembly, and a setting of the set screw valve, the set screw has, at its outer end, means to accommodate the installation of a turning tool, such as an Allen wrench, or screwdriver, or other tool, that allows for the turning of the set screw valve within its handle bushing, and which when it is turned inwardly, to its fullest extent, it will curtail the flow of vapors back through the handle, to the vapor return line, as when it seats and closes off the vapor return line that extends through the vapor line bushing, as previously described. Furthermore, during its adjustment, the set screw valve may be partially or fully threadedly disengaged from within the vapor flow line bushing, that allows for a full opening of the vapor return line, and a full flow of the vapors being returned back through the nozzle and to the dispenser, for transfer to storage. And, when a finer adjustment is sought for the back pressure of the vapors passing through the vapor return line, the set screw valve can be turned more inwardly, or outwardly, in order to get a balanced flow of pure gasoline vapors back through the nozzle handle, with a minimum of draw in of the pure atmospheric air, during the functioning of the vapor control means, returning pure vapors back through the nozzle, for storage, as known and required in the art.

It is, therefore, the principal object of this invention to provide structural means within the handle of a gasoline dispensing nozzle, in the form of a set screw valve, cooperating with a valve seat within a vapor return line bushing, that allows for the adjustment in the degree and amount of fuel vapors being returned from the vicinity of the dispensing of gasoline from a fuel dispensing nozzle into a vehicle or other storage tank. It should be further understood that the set screw valve can be otherwise positioned within the handle of a gasoline dispensing nozzle to cooperate with a valve seat likewise positioned in other locations of the gasoline dispensing nozzle to allow for the adjustment in the degree and amount of fuel vapors being returned. For example, the valve seat can be positioned upstream of the bushing, relative to the return flow of vapors, and in, partially or completely, a vapor flow line. The set screw valve is positioned to cooperate with a valve seat in such a position.

A further object of this invention is to provide the structural means im the form of a vapor control valve that can provide for the adjustment in the back pressure setting in the vapor return line in an effort to maximize the return of natural fuel vapors back to usually the underground storage tank, while collecting the minimum of fresh atmospheric air during the functioning of a vapor return line associated with a fuel dispensing nozzle.

A further object of this invention is to provide a set screw valve means that cooperates with a vapor return line bushing, provided within the vapor return line, interiorly of the gasoline dispensing nozzle, while the adjustment features are readily available exteriorly, to provide for adjusting the set screw valve to that back pressure setting considered most desirable for returning pure fuel vapors back to the storage facility, during the dispensing of gasoline.

A further object of this invention is to provide for convenient control of gasoline vapors emitted during fuel dispensing, to a structure that is totally operatively associated with the fuel dispensing nozzle handle, without requiring any manipulation of extraneous controls, other than what is set forth for the structure of this invention and installed within the handle of a fuel dispensing nozzle.

These an other objects may become more apparent to those skilled in the art upon review of the invention as described herein, and upon undertaking a study of its preferred embodiment, in view of the associated drawings.

### BRIEF DESCRIPTION OF THE DRAWINGS

In referring to the drawings:

FIG. 1 shows a side view of a fuel dispensing nozzle showing the location of the vapor control set screw valve of this invention;

FIG. 2 is a sectional view through the center line of the nozzle handle, showing the location of the vapor control set screw valve of this invention;

FIG. 3 is a sectional view disclosing the location of the vapor control set screw valve of this invention provided within the handle of the fuel dispensing nozzle;

FIG. 4 is an enlarged view of the valve of FIG. 3;

FIG. 5 is an isometric view of the set screw valve of this invention;

FIG. 6 shows the vapor control set screw valve of this invention being fully inserted within the nozzle handle and extending into the vapor return line of the handle for the fuel dispensing nozzle; and

FIG. 7 shows an alternative embodiment of a fuel dispensing nozzle with the vapor control set screw of this invention, the vapor control set screw being accessible from a top side of the fuel dispensing nozzle.

### DESCRIPTION OF THE PREFERRED EMBODIMENT

As previously reviewed, the subject matter of this invention includes the addition of a vapor control set screw valve for use in combination with a fuel dispensing nozzle, so as to allow for the adjustment to back pressure of the gasoline vapors being returned through the nozzle, in the dispenser, and for transfer into usually the underground storage tank for the fuel.

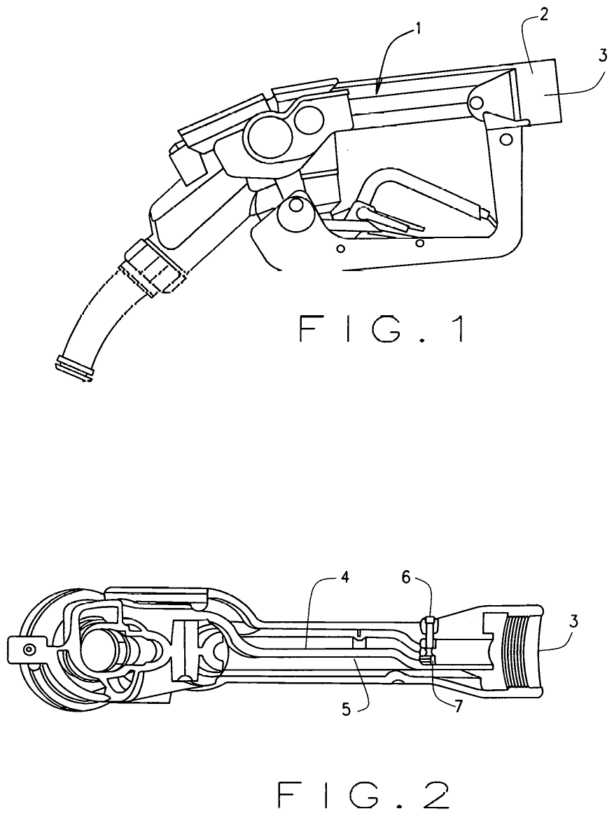

As can be seen in FIG. 1, the nozzle 1 is of a standard type of nozzle usually of the vacuum assist type, such as marketed by the owner of the invention herein, Husky Corporation, of Pacific, Mo. As noted, the handle 2, at its back end, usually connects with the fuel flow line hose (not shown), and such a hose is normally of a coaxial or parallel axis type, having a fuel vapor return flow line provided within such a hose structure. Normally, these hoses connect to the back end 3 of the shown nozzle, for example, using a coaxial coupling adapted and configured to engage with a threaded opening of the back end 3. As can also be seen in FIG. 2, the vapor flow line can be noted at 4, while the fuel flow line is generally disclosed at 5 and which line may be coaxial, or arranged side by side, as can be seen.

The vapor control set screw valve, as noted at 6, and it extends through the side of the nozzle, in this embodiment, and extends all the way through to the approximate center of the nozzle, at a location at approximately at the vapor flow line, as noted at 7.

The object of this invention, as previously summarized, is to provide the means and structure to allow for adjustment to the opening through the vapor flow line, so as to adjust the back pressure of the vapors being taken into the nozzle, at the region of the front of its spout, in order to capture the same, and to prevent such vapor from being emitted into the atmosphere, as previously reviewed.

Normally, with the use of the standard type of vacuum assist nozzle, and the application of a small vacuum pump in the dispenser, communicating with the vapor return line provided within the hose, and the connected nozzle, the flow of such vapors in their return to the dispenser is normally in the range of approximately 0.4 cfm to 1.3 cfm, during standard usage and application of the dispensing mechanisms. Thus, under those standard operating conditions, where the vapors are being sucked back into through the nozzle, to the dispenser, and pumped to the underground storage tank for capture, it has been found that not only are the gasoline vapors being attracted therethrough, but that because of the variations in the velocity of the moving vapors, that the suction force provided at the tip end of the nozzle may be excessive enough to also draw in a significant amount of atmospheric air, which means that an oversupply of not only the fuel vapors, but also the ambient air, are being returned and stored in the fuel storage tank, whereby filling the capacity of the storage tank to hold vapors, includes a substantial amount of the atmospheric air, which may be undesirable.

Hence, the concept of this invention is to provide for that means for adjustment to the vapor control valve, to block the vapor flow path adjustably partially through the nozzle, generating a back pressure, which may be regulated and controlled, to a precise point that returns the maximum amount of vapors and minimal amount of ambient air through the nozzle.

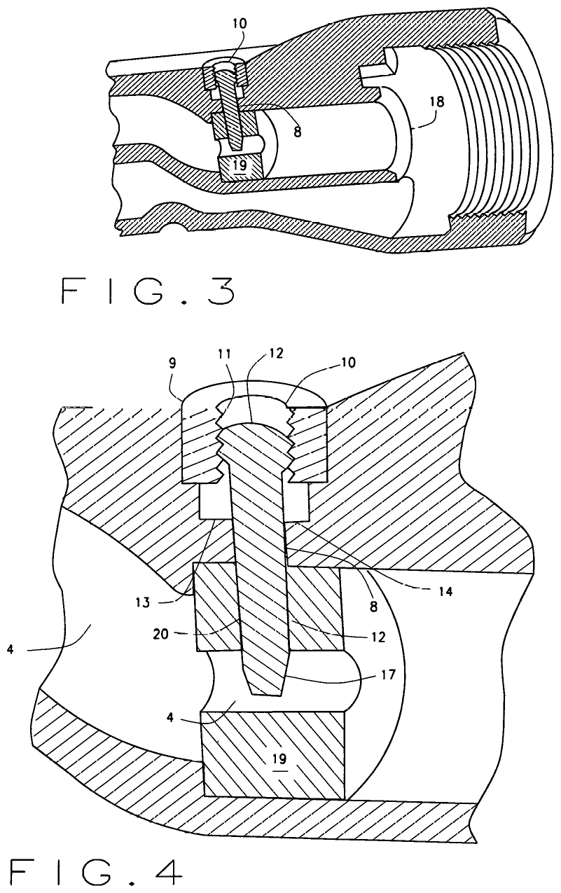

To achieve the foregoing, the nozzle handle has a channel 8 provided therethrough that is transverse to the flow within and can be lateral (e.g., as depicted), and that channel has an outer counterbore 9 and into which an insert bushing 10 may locate, and be secured within said counterbore, either by means of a pressure fit, an adhesive, or even threadedly engaged therein, and as can be noted, the interior of the bushing insert is threaded, as at 11, and is receptive to the threaded engagement of the set screw valve 12 as can be noted. Furthermore, to provide for a proper sealing of these components together, an O-ring 13 is located at the inner end of the insert bushing 10, and can be compressed within its seat 14 and bias against the surface of the set screw valve, as noted, to provide for a sealing engagement therein. These can all be seen in FIGS. 3 and 4 of the drawings.

Furthermore, the set screw valve 12, as noted at FIG. 5, has an upper integral end that is also threaded, as at 15 and further has an engagement surface, as at 16, into which an Allen wrench, screwdriver, or other tool may engage, in order to provide for a turning and fine setting of the set screw within the insert bushing 9, during its adjustment. The opposite end of the set screw valve may have a slight taper, as at 17, and this end of the valve is designed for locating within the vapor flow path, as noted at 4, in FIG. 4, to partially block the flow of fuel vapors from the front tip end of the nozzle, as they are absorbed and returned back to storage.

To accommodate the inner end of the set screw valve 12, there is provided intermediate the vapor return line structured in the nozzle, and the vapor return line hose, as noted at 18, a structured valve bushing 19 that is secured intermediate these two portions of the vapor return line, as can be seen clearly in FIG. 4. This bushing also may be press fit within the location between the vapor return lines, as noted, and provided within the structure of the nozzle, at this location, and any form of fitting, whether it be a pressure fitting, fastened by other components, or adhesively applied in place, to provide for a more permanent installation of such bushing 19 within the nozzle structure.

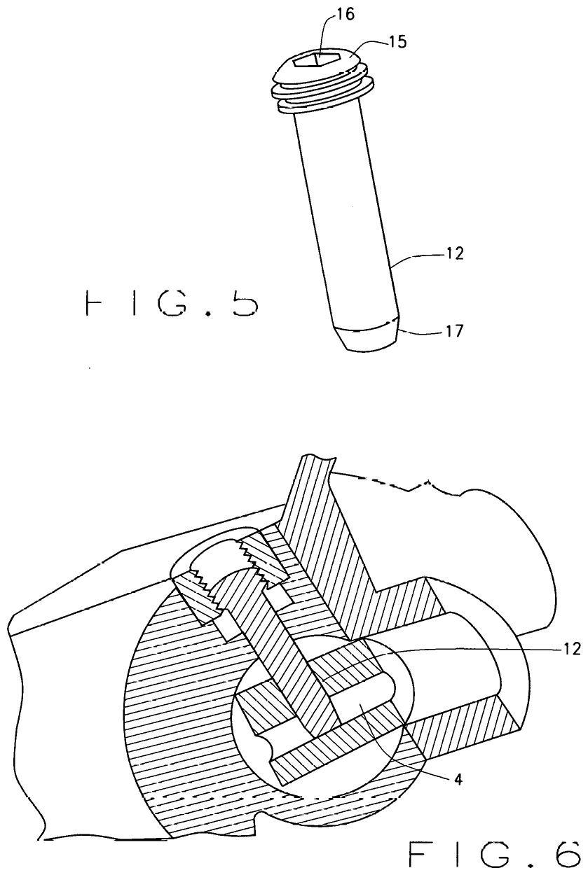

FIG. 4 shows how the set screw valve extends through a transverse, lateral aperture 20 provided through the valve bushing, and how that aperture communicates with the vapor flow line 4, structured through the bushing 19, as can be noted. FIG. 4 shows how the inner end 17 of the valve is entering into the vapor return path 4, while FIG. 6 shows how the set screw valve has entered fully into the vapor flow line 4, and thereby blocks the return of the fuel vapors back to the dispenser, when the set screw valve is fully installed. But, somewhere between a full insertion, as shown in FIG. 6, or a partial insertion of the valve, as noted in FIG. 4, will provide a sufficient amount of back pressure for the returning vapors that can be determined to prevent the attraction of the purer ambient air surrounding the tip dispensing end of the nozzle, as can be understood. It has been found that a back pressure generated within a range of 2″ W.C.-60″ W.C., is effective in returning the gasoline vapors back to the dispenser, while minimizing the absorption of the purer ambient air surrounding the tip end of the nozzle, during the dispensing of fuel from the spout end of the nozzle, inserted within the fill pipe of a fuel tank.

For further explanation, the various components that form the set screw valve, the vapor return line bushing, or the insert bushing that are used in the fabrication of the valve of this invention, may be formed of metal, a polymer, or any related materials that may not deteriorate when subjected to prolonged usage and exposure to fuels, such as gasoline, or the like.

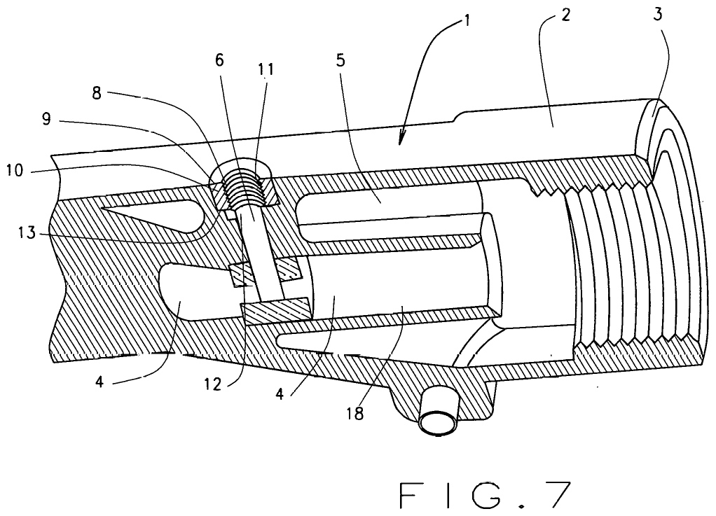

Referring now to FIG. 7, an alternative embodiment of the nozzle 1 is depicted. In this alternative embodiment, the lateral channel 8 through which the set screw extends is positioned vertically through the top of the nozzle and transverse to the flow of fuel and/or vapor within the nozzle. This alternative embodiment differs from the embodiment shown in FIGS. 1-6 in that in the embodiment depicted in FIGS. 1-6 the channel 6 extends laterally through a side of the nozzle 1. Positioning the set screw 6 such that it can be accessed on or through a top surface of the nozzle 1, as depicted in FIG. 7, provides an advantage in that the set screw can be easily seen and manipulated while the nozzle is being held. In the embodiment depicted in FIG. 7 parts numbered in like fashion to those parts in FIGS. 1-6 are the same or of similar characteristics.

Variations or modifications to the subject matter of this invention may occur to those skilled in the art upon review of the structure and functionality of this valve, as defined herein. Such variations, if within the spirit of this invention, are intended to be encompassed within the scope of any claims to patent protection issuing upon this valve device. The definition of the invention as summarized herein, as explained in detail for the preferred embodiment, and as depicted in the drawings, are set forth for illustrative purposes only.

We claim:

1. A vapor control adjustment valve for use in a vapor assist fuel dispensing nozzle of the type having a nozzle handle, a connected forward end spout, and various valves to provide for an on-off for the dispensing of fuel, an automatic shut-off mechanism, and a fuel dispensing flow path through the nozzle, and a vapor return line for collection and returning fuel vapors back to the dispenser and for storage, comprising:
said vapor control adjustment valve being installed in the handle of the said fuel dispensing nozzle, said valve including a vapor bushing inserted into the vapor return line, said vapor bushing having a vapor flow path provided therethrough and of a size similar to the size of the vapor flow path of the nozzle through which the vapor bushing inserts, there being a further channel extending angularly through said vapor hushing and extending to the surface of the nozzle handle and opening exteriorly thereof;
an insert bushing inserting into the channel at the surface of the said handle, a valve stem extending into the handle channel, through the said insert bushing and into the vapor flow path of said vapor bushing and capable of being adjustably inserted into the vapor flow path of said vapor bushing to develop an adjustment in the back pressure generated within the vapor flow line for the returning fuel vapors, and reduce the percentage of fresh ambient air absorbed into the fuel vapors being returned through the vapor return line to the dispenser for storage.

2. The vapor control adjustment valve of claim 1 wherein said insert bushing having internal threads, and said valve stem capable of threadedly engaging within said threaded insert bushing to adjust the extension of said valve stem into the vapor flow path of said vapor bushing to change the back pressure generated in the vapor flow line and to regulate the quality of the vapors returning to the dispenser during fuel dispensing.

3. A vapor control adjustment valve of claim 2, wherein said handle channel having a counterbore provided therein, said insert bushing pressure fitting within said handle channel, and an O-ring provided within the handle channel against which the insert bushing biases in order to seal off and prevent the escape of vapors from bypassing the valve stem and escaping from the nozzle handle.

4. The vapor control adjustment valve of claim 2, wherein said valve stem at its inwardly extending end has a diameter similar to the further channel extending through said valve bushing wherein upon the adjustment of the valve stem into the vapor flow path provided through the vapor bushing providing for an adjustable obstruction to the flow of fuel vapors back to the dispenser thereby increasing the back pressure of said vapors during their return to said dispenser.

5. The vapor control adjustment valve of claim 1, wherein said handle channel extends through a side of the nozzle handle and is transverse to the vapor flow path.

6. The vapor control adjustment valve of claim 1, wherein said handle channel extends through a top of the nozzle handle and is transverse to the vapor flow path.

7. A vapor control adjustment valve for use on a vacuum assist fuel dispensing nozzle of the type having a nozzle handle, a connected forwardly extending spout, and various valves to provide for the on/off for the dispensing of fuel, a handle automatic shut-off, and a fuel dispensing flow path through the nozzle, and a vapor return line for collecting and returning fuel vapors back to the dispenser and for storage, comprising:
a vapor control adjustment valve adjustably installed in the handle of the fuel dispensing nozzle, said control valve capable of adjustably extending into the vapor return line of the handle, and therein generating a back pressure in the return of the fuel vapors through the handle and to the dispenser for storage, thereby providing a means for regulating and reducing the attraction of ambient air at the front of the nozzle spout from intermixing with the returning fuel vapors during dispensing of fuel from the fuel dispensing nozzle.
